(19) United States
(12) Patent Application Publication
(10) Pub. No.: US 2015/0109081 A1
(43) Pub. Date: Apr. 23, 2015

(54) CAST COIL ASSEMBLY WITH FINS FOR AN ELECTRICAL TRANSFORMER

(71) Applicant: Hammond Power Solutions, Inc., Guelph (CA)

(72) Inventor: Dhiru S. Patel, Guelph (CA)

(73) Assignee: Hammond Power Solutions, Inc., Guelph (CA)

(21) Appl. No.: 14/058,911

(22) Filed: Oct. 21, 2013

(51) Int. Cl. H01F 27/08

(52) U.S. Cl. CPC H01F 27/085
USPC 336/60

(57) ABSTRACT

A transformer comprises a core of magnetic permeable material. A first coil assembly extends around the core and includes a first coil of wire encased in a first body of electrical insulating material. The first body is annular with a first inner surface and a first outer surface with a first plurality of fins projecting from the first inner surface. A second coil assembly extends around the first coil assembly and includes a second coil encased in a second body of electrical insulating material. The second body is annular with a second inner surface and a second outer surface with a second plurality of fins projecting from the second outer surface. A third plurality of fins projects from either the first outer surface of the first body or the second inner surface of the second body.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to electrical transformers, and more particularly to cast coil assemblies used in the transformers.

2. Description of the Related Art

Transformers are conventional electrical devices for converting alternating electricity at a first voltage level to a second voltage level. The second voltage level may be greater or lesser than the first voltage level. A transformer has a primary coil of wire that is inductively coupled to a secondary coil of wire. To enhance the inductive coupling, the primary and secondary coils are often wound around a core of very high magnetic permeability, for example iron cores are usually used. The alternating input voltage is applied to the primary coil which generates an electromagnetic field that is coupled through the core to the secondary coil. That coupling induces alternating voltage in the secondary coil, thereby producing the output current from the transformer when a load is connected.

A common transformer design has circular primary and secondary coils coaxial arranged with one coil inside the other coil. A leg of the core, having a circular cross section, extends through the bore of the inner coil. A three-phase transformer has three of these coaxial coil arrangements located side by side around three legs of an E-shaped core section. A drawback of this design is that the circular coils result is a relatively wide transformer, especially when three such coil assemblies are placed side by side for a three-phase transformer.

It has been proposed to use a core that has core legs with a rectangular cross section. Conventional coaxial coils are separately wound on an arbor and then slid onto the leg of the core. However, when a large gauge wire of the inner coil is wound around a rectangular cross section arbor, the wire cannot make sharp bends at the corners of the arbor. As a result the inner coil bulges outward along the short sides of the arbor. The amount and size of the bulging varies from coil to coil. Thus the shape and size of the inner coil for the transformer cannot have dimensions with small tolerances, which means that the outer coil must be over sized so that can be slide over the inner coil with worst case dimensions. This also increases the outer dimensions of the transformer.

Another issue relates to electricity flowing through the transformer coils generating heat that needs to be dissipated. Cooling is commonly accomplished by creating an annular gap between inner and outer coils and sometimes between layers of the winding of each coil so that air is able to flow through the transformer. It is desirable to optimize the cooling of the air flow with minimal size gaps to keep the transformer relatively compact.

The low voltage and high voltage windings are separated by a dielectric medium, typically air or a resin material. Air is a relatively weaker dielectric medium than resin materials and large air gap is typically provided to withstand the voltage differentials between low and high voltage windings. Reducing the space between the low and high voltage winding is desirable.

Therefore, there still is a desire to further improve the transformer design.

### SUMMARY OF THE INVENTION

A transformer includes a core of magnetic permeable material around which both a first coil assembly and a second coil assembly extend. The first coil assembly includes a first coil of an electrical conductor embedded in a first body of electrical insulating material, wherein the first body is annular with a first inner surface and a first outer surface. The second coil assembly extends around the first coil assembly and includes a second coil embedded in a second body of electrical insulating material. The second body is annular with a second inner surface and a second outer surface.

At least one of the first inner surface, the first outer surface, the second inner surface, and the second outer surface has a plurality of fins forming channels for air to flow through.

In one aspect of the present transformer, the first body and the second body are formed by resin material, and the plurality of fins is formed of that resin material integral with the respective one of the first body and the second body.

In one embodiment, the transformer comprises a core of magnetic permeable material. A first coil assembly extends around the core and includes a first electrical conductive coil encased in a first body of electrical insulating material. The first body is annular with a first inner surface and a first outer surface. The first coil assembly further comprises a first plurality of fins projecting from the first inner surface. A second coil assembly extends around the first coil assembly and includes a second coil encased in a second body of electrical insulating material. The second body is annular with a second inner surface and a second outer surface. The second coil assembly further comprises a second plurality of fins projecting from the second outer surface. A third plurality of fins projects from either the first outer surface of the first body or the second inner surface of the second body.

### BRIEF DESCRIPTION OF THE DRAWINGS

FIG. 1 is a perspective view of a three-phase transformer that incorporates the present invention;

FIG. 2 is a cross sectional view through the transformer along line 2-2 in FIG. 1;

FIG. 3 is a cross sectional view along line 3-3 in FIG. 2 through one phase coil assembly of the transformer that has a shield within the outer coil assembly;

FIG. 4 is a perspective view of a cast coil assembly in which the casting material forms a plurality of fins;

FIG. 5 is perspective view of a mesh type shield used in a coil assembly;

FIG. 6 is perspective view of a solid type shield used in a coil assembly;

FIG. 7 is a partial cross sectional view of a cast coil assembly in which ends of the shield overlap;

FIG. 8 is a partial cross sectional view of a cast coil assembly in which ends of the shield are spaced apart; and

FIG. 9 is a cross sectional view through an embodiment of one phase coil assembly that has a shield within the inner coil assembly.

### DETAILED DESCRIPTION OF THE INVENTION

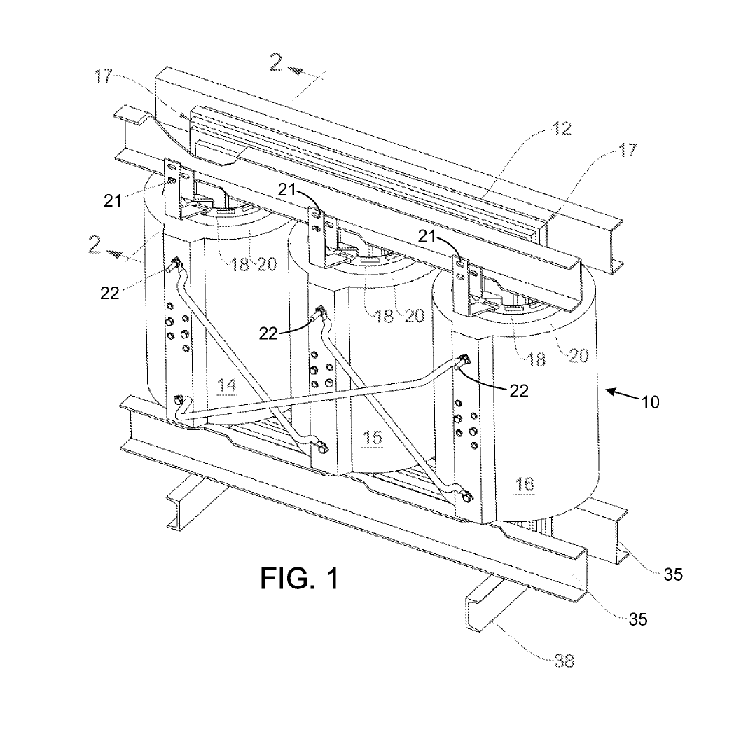

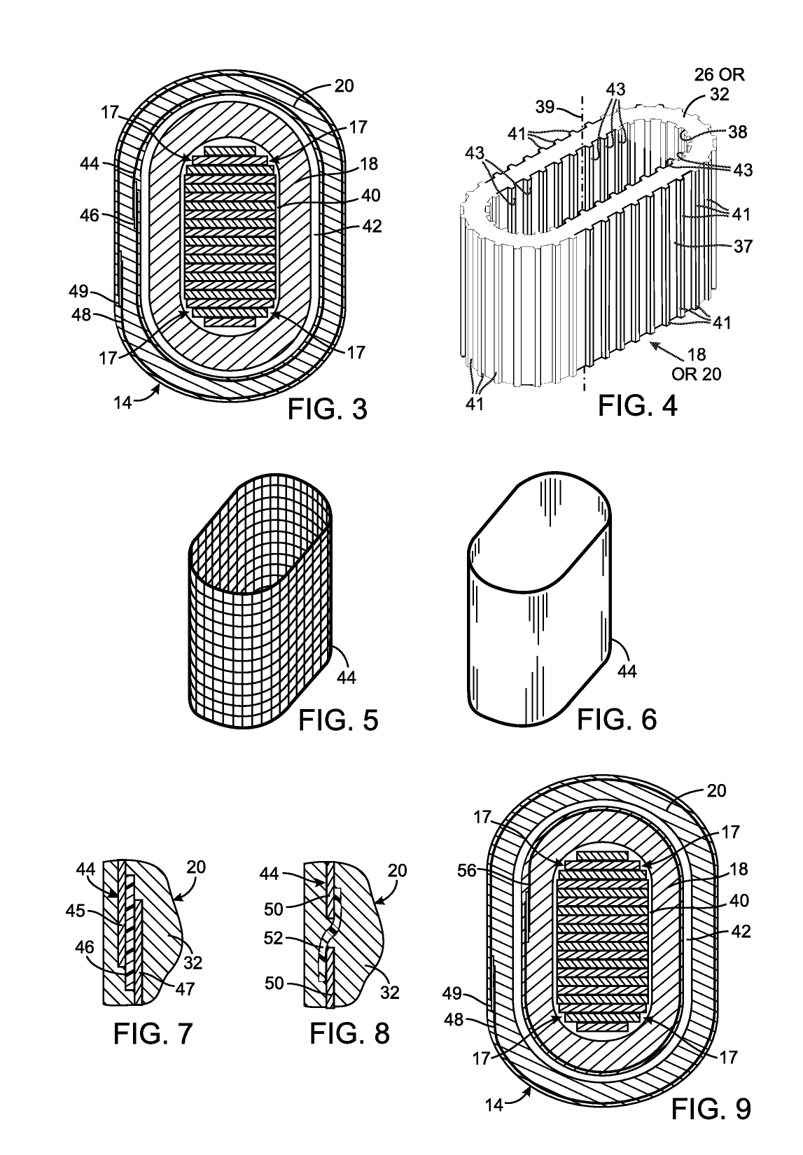

Referring initially to FIGS. 1-3, a three-phase transformer 10 includes a magnetic core 12 that has top and bottom members between which three legs extend. A separate one of three phase assemblies 14, 15 and 16 is wound around each leg with each phase assembly having individual first and second coil assemblies 18 and 20. The core 12 is formed of a material having a relatively high magnetic permeability, such as a ferromagnetic metal, so that each pair of the first and second coil assemblies 18 and 20 is inductively coupled through core. The core 12 comprises a plurality of magnetically permeable sheets laminated together. Several outer sheets on both sides of the core are shorter than the inner sheets so that the corners 17 of the legs are stepped to conform to the curvature of the annular bore of the corresponding phase assemblies 14, 15 and 16 through which the leg extends, as shown in particular in FIG. 3.

In each phase assembly 14-16, the inner first coil assembly 18 that is closest to the core 12 and may serve as a low voltage coil. In which case, the outer second coil assembly 20, extending coaxially around the first coil assembly 18, functions as a high voltage coil. The first coil assembly 18 has start and finish leads connected to a set of low voltage terminals 21. The second coil assembly 20 in each assembly 14-16 is electrically connected to a set of high voltage terminals 22.

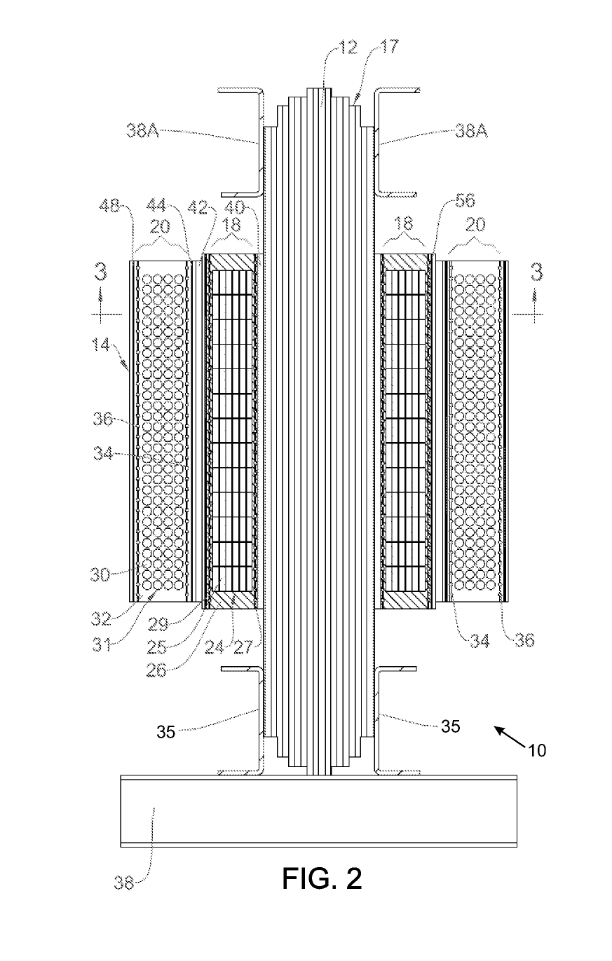

The details of the first phase assembly 14 are shown in FIGS. 2 and 3 with the understanding that the second and third phase assemblies 15 and 16 have the same construction. The inner, first coil assembly 18 comprises a first electrical conductor 25, such as a wire or foil strip, for example, wound around the core 12 in a first coil 24 having a plurality of winding layers and encapsulated in a first body 26 of an electrically insulating material, for example a resin, such as an epoxy material. The first coil assembly 18 includes an inner first reinforcing sheet 27 and an outer second reinforcing sheet 29, each in the form of a mesh of non-electrically conductive material extending in loops around the first coil assembly. The reinforcing sheets 27 and 29 strengthen the first body 26 acting to prevent the resin material from cracking due to thermal cycling of the coil assembly. One reinforcing sheet 27 or 29 may be eliminated for smaller power transformers. In another variation, one or more mesh reinforcing sheets can be placed between winding layers of the first coil 24.

The outer, second coil assembly 20 comprises a second electrical conductor 30, such as a wire or foil strip, wound around the inner, first coil assembly 18, and thus also around the core 12, to form a second coil 31 with another plurality of winding layers encapsulated in a second body 32 of the resin material. The second coil assembly 20 includes an inner third reinforcing sheet 34 and an outer fourth reinforcing sheet 36 both of a mesh of non-electrically conductive material extending in loops around the second coil assembly. Here also, one of the third and fourth reinforcing sheets 34 or 36 may be eliminated in certain transformer designs and other reinforcing sheets can be placed between the winding layers of the second coil 31.

Each of the first and second coil assemblies 18 and 20 is fabricated by winding the respective electrical conductor around an arbor that has an outer dimension and shape corresponding to the desired internal surface of the first or second coil 24 or 31. The completed coil is then removed from the arbor and placed in a mold along with the inner and outer reinforcing sheets 27 and 29 or 34 and 36. The reinforcing sheets are spaced from the walls of the mold. The mold is sealed, the air is evacuated, and then filled with the resin material that is allowed to cure thereby forming the completed first or second coil assembly 18 or 20.

The core 12 is fabricated in two sub-assemblies each a lamination of multiple sheets of magnetically permeable material. A first sub-assembly is shaped like the letter E and the second sub-assembly is a straight member. The inner first coil assembly 18 for each of the phase assemblies 14, 15, and 16 is then inserted onto the respective leg of the core 12. As shown in FIG. 2, it is desirable to have an annular gap 40 between the inner, first coil assembly 18 and the core. The second coil assembly 20 is then inserted around the first coil assembly 18. It is also advantageous to provide another gap 42 between the inner first coil assembly 18 and the outer second coil assembly 20. These gaps 40 and 42 provide electrical separation and passages through which air can flow to cool the coil assemblies. Spacers may be used to maintain these gaps.

The straight second core sub-assembly is then secured to the ends of the legs of the first core sub-assembly in a conventional manner to complete a magnetic circuit. Then, the core 12 and the three phase assemblies 14-16 can be secured to core clamps 35 and a base 38.

With reference to FIG. 4, the dissipation of heat can be enhanced by having a plurality of external fins 41 extending longitudinally to the coil axis and on the exterior surface 37 of the coil body 26 or 32, respectively. A plurality of internal fins 43 also can extend inward from the interior surface 38 of the coil body 26 or 32. The pluralities of external and internal fins 41 and 43 are formed of the resin material used for the main part of the coil bodies and are formed integral therewith during the molding process. The fins 41 and 43 extend vertically parallel to the core legs, thereby forming channels in which air can flow through the transformer. The fins of the resin material increase the surface area of the coil bodies 26 and 34 thereby increasing the transfer of to the air flow. Each of the coil bodies 26 and 32 may have fins only on one of the exterior surface 37 or the interior surface 38. For example, only one of the coil bodies 26 and 32 may have fins in the annular gap 42 between the first and second coil assemblies 18 and 20.

With reference to FIGS. 2 and 3, to capacitively decouple the first and second coil assemblies 18 and 20, a first shield 44 extends in a loop within the inner circumference of the second coil 31 encased by being embedded in the second resin body 32 of the outer second coil assembly 20. The first shield 44 is connected to ground and is preferably a non-magnetic, electrically conductive material, such as aluminum or copper. The first shield 44 preferably is a wire mesh or screen as shown in FIG. 5, however, a solid sheet of material as in FIG. 6 may be used. With additional reference to FIG. 7, the loop of the first shield 44 has end sections 45 and 47 that overlap, but do not touch each other. A strip 46 of electrically insulated material is placed between the overlapping end sections 45 and 47 so that the first shield 44 does not form a continuous conductive loop within the first coil assembly 18. Alternatively, instead of using an insulating strip 46, the end sections 45 and 47 can be held apart during the molding operation so that the resin material extends there between to provide electrical insulation. FIG. 8 depicts another version of the first shield 44 in which a sheet 50 of electrically conductive, non-magnetic material wraps in an open loop around the second coil assembly 20 with ends of that loop spaced slightly apart and thus do not overlap. A separate strip 52 of electrical insulating material is placed across the gap between the two ends of the shield loop. The insulating strip 52 has a zigzag shape with one side of the strip located inside the adjacent end of the shield and the other side of the strip located outside the opposite end of the shield.

An alternative when the voltage applied to the first coil assembly 18 exceeds 2400 volts, a first shield 56 can be embedded in the first coil assembly extending around the outside of the first coil 24 as shown in FIG. 9.

The basic principle is that a grounded electrically conductive, non-magnetic first shield is located between the first and second coils 24 and 31 in each constructed phase assembly 14-16. By using such a first shield 44 or 56, the dielectric requirement between the first and second coil assemblies 18 and 20 is replaced by the dielectric requirement between the first coil assembly 18 and the grounded first shield. The withstand capability of that latter dielectric requirement is provided by resin with much smaller space as resin has much higher dielectric withstand capability than air. The first shield 44 also mitigates any arcs from occurring between the two coils 24 and 31. As a result, the annular gap 42 between the first and second coil assemblies 18 and 20 can be reduced from the distance necessary in the absence of the grounded first shield 44 or 56 which was significantly larger than needed for air cooling alone. Thus, the transformer 10 with three phase assemblies 14-16 according to this novel design has significantly smaller length and width. As an alternative, the thickness of the resin near the surfaces of the coil bodies 26 and 32 can be increased to provide greater electrical isolation further allowing the annular gap 42 between the coil assemblies to be reduced more.

With reference again to FIGS. 2 and 3, a further feature of each phase assembly 14-16 is an electrically conductive, outer second shield 48 embedded in the second body 32 of the second coil assembly 20. The second shield 48 extends in a loop around and encircling the second coil 31 and has spaced apart end sections similar to those of the first shield 44. Either a strip of insulation 49 or the resin of the coil body 32 is present between those end sections. Enough resin of the coil body 32 is present between the second coil 31 and the second shield 48 to provide a sufficient dielectric thickness for continuous operation, fault conditions, and transient voltages including impulses. Unlike the first shield 44, however, the second shield 48 may be made of either magnetic or non-magnetic material, such as a metal. The second shield 48 is grounded, thus forming a ground plane just inside the outer surfaces of two adjacent phase coils 14-16 thereby eliminating a need for a dielectric space. Only as relatively small gap adjacent phase coils is required for cooling air circulation. This further reduces the length of the transformer 10.

An outer second shield 48 of a magnetic material also reduces electromagnetic field emission from the transformer 10 and diminishes electromagnetic interference with other nearby electrical equipment. Such a coil assembly also protects the coil assemblies for the other phases during the single phase fault condition.

All the various shields 44, 48, and 56 can be formed either as a wire mesh or a solid sheet of material and can form a loop with spaced apart ends configured as shown in FIGS. 7 and 8, for example.

The foregoing description was primarily directed to one or more embodiments of the invention. Although some attention has been given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A transformer comprising:
a core of magnetic permeable material;
a first coil assembly extending around the core and including a first coil of wire embedded in a first body of electrical insulating material, wherein the first body is annular with a first inner surface and a first outer surface; and
a second coil assembly extending around the first coil assembly and including a second coil encased in a second body of electrical insulating material, wherein the second body is annular with a second inner surface and a second outer surface;
wherein at least one of the first inner surface, the first outer surface, the second inner surface, and the second outer surface has a plurality of fins forming channels for air to flow through.

2. The transformer as recited in claim 1 wherein the first body and the second body are formed by resin material, and the plurality of fins is formed of that resin material integral with the respective one of the first body and the second body.

3. A transformer comprising:
a core of magnetic permeable material;
a first coil assembly extending around the core and including a first coil of wire embedded in a first body of electrical insulating material, wherein the first body is annular with a first inner surface and a first outer surface, the first body further comprising a first plurality of fins projecting from the first inner surface and forming channels for air to flow through; and
a second coil assembly extending around the first coil assembly and including a second coil embedded in a second body of electrical insulating material, wherein the second body is annular with a second inner surface and a second outer surface, the second body further comprising a second plurality of fins projecting from the second outer surface and forming channels for air to flow through.

4. The transformer as recited in claim 3 further comprising a third plurality of fins projecting from one of the first outer surface of the first body and the second inner surface of the second body, wherein the third plurality of fins forms air flow channels between the first and second coil assemblies.

5. The transformer as recited in claim 4 wherein the first body and the first plurality of fins are formed of a single mass of resin material, the second body and the second plurality of fins are formed of another single mass of resin material, and the third plurality of fins is formed by the same mass of resin material as forms the respective one of the first body and the second body.

6. The transformer as recited in claim 3 wherein the first body and the first plurality of fins are formed of a single mass of resin material, and the second body and the second plurality of fins are formed of another single mass of resin material.

7. The transformer as recited in claim 3 further comprising:
a third plurality of fins projecting from the first outer surface of the first body and forming air flow channels between the first and second coil assemblies; and
a fourth plurality of fins projecting from the second inner surface of the second body and forming air flow channels between the first and second coil assemblies.

8. The transformer as recited in claim 7 wherein the first body and the third plurality of fins are formed of a single mass of resin material and the second body and the fourth plurality of fins are formed of another single mass of resin material.
